(19) United States
(12) Patent Application Publication
(10) Pub. No.: US 2018/0160165 A1
(43) Pub. Date: Jun. 7, 2018

(54) Long-Hold Video Surfing

(71) Applicant: Google Inc., Mountain View, CA (US)

(72) Inventor: Neil P. Cormican, Menlo Park, CA (US)

(73) Assignee: Google Inc., Mountain View, CA (US)

(21) Appl. No.: 15/371,082

(22) Filed: Dec. 6, 2016

(51) Int. Cl. H04N 21/422; H04N 21/472; H04N 21/41; G06F 3/0488

(52) U.S. Cl. CPC H04N 21/42224; H04N 21/47202; G06F 3/0482; G06F 3/04883; H04N 21/4126

(57) ABSTRACT

This document describes methodologies for long-hold video surfing. These techniques and apparatuses enable improved navigation for video and channel previewing based on long-hold gestures performed on a mobile device acting as a remote control to a remote display device. These techniques and apparatuses allow non-linear navigation over many channels with a simple and easy method to return to a previous channel. Further, these techniques and apparatuses can also be applied to surf on demand media content.

### BACKGROUND

Television viewers generally use remote controllers to navigate through a list of channels of a television service. Many viewers tend to engage in “channel surfing”, which is the process of quickly scanning through different television channels to find content of interest. Conventional remote controllers enable channel navigation via selection of channel UP or channel DOWN buttons to cycle through the channel list and view content currently being distributed (e.g., broadcast), or selection of specific channel numbers, such as by sequentially pressing buttons 1, 4, and 6 to select channel 146. Unless the user knows the exact channel number, the user is required to navigate the list of channels in sequence from one channel to the next.

These forms of navigating television channels can be frustrating to the user for a variety of reasons. For example, the channels are arranged in a preset order by a service provider, but specific channels in which the user is interested may be far apart in the list. In order to navigate between two or three channels that are not proximate one another in the list of channels, the user is required to either press the specific channel numbers on the remote controller or navigate sequentially through all channels between those two or three channels. In addition, using the channel UP/DOWN buttons, the user is required to follow the sequence in which the channels are ordered. Further, navigating the channels in this way may require a substantial amount of button presses on the remote controller, which can be tiresome and frustrating for users.

This background description is provided for the purpose of generally presenting the context of the disclosure. Unless otherwise indicated herein, material described in this section is neither expressly nor impliedly admitted to be prior art to the present disclosure or the appended claims.

### BRIEF DESCRIPTION OF THE DRAWINGS

Apparatuses of and techniques using methodologies for long-hold video surfing are described with reference to the following drawings. The same numbers are used throughout the drawings to reference like features and components:

FIG. 1 illustrates an example environment in which methodologies for long-hold video surfing can be embodied.

FIG. 2 illustrates an example implementation of a mobile computing device of FIG. 1 in greater detail in accordance with one or more embodiments.

FIG. 3 illustrates an example implementation of a long-hold gesture in accordance with one or more embodiments.

FIG. 4 illustrates an example scenario of a slide-and-hold gesture in accordance with one or more embodiments.

FIG. 5 illustrates an example scenario that implements a timing aspect of long-hold video surfing in accordance with one or more embodiments.

FIG. 6 illustrates an example scenario in which techniques for long-hold video surfing are implemented in accordance with one or more embodiments.

FIG. 7 illustrates an example scenario in which techniques for long-hold video surfing can be implemented in accordance with one or more embodiments.

FIG. 8 illustrates an example scenario in which a mobile computing device includes a user interface that facilitates long-hold video surfing in accordance with one or more embodiments.

FIG. 9 illustrates example methods of navigating media content using methodologies for long-hold video surfing in accordance with one or more embodiments.

FIG. 10 illustrates example methods for navigating media content using methodologies for long-hold video surfing in accordance with one or more embodiments.

FIG. 11 illustrates various components of an electronic device that can implement methodologies for long-hold video surfing in accordance with one or more embodiments.

### DETAILED DESCRIPTION

Overview

Conventional techniques that allow users to channel surf through media content, such as live television, are inefficient at least because users are required to navigate the channels one by one in a linear fashion (e.g., channel up, channel down), or by pressing numerical buttons to navigate to a particular channel. This form of channel surfing to find content of interest is time consuming, and may result in more time spent surfing the channels than actually viewing content of interest.

The methodologies for long-hold video surfing described herein improve navigation for video and channel previewing based on long-hold gestures performed on a mobile device acting as a remote controller of a remote display device. These techniques and apparatuses enable users to quickly and easily choose the order in which to surf the channels, such as any non-linear order. These techniques and apparatuses also provide a simple and easy method to return to a channel that was being presented prior to surfing the channels. Further, these techniques and apparatuses can also be applied to surf video-on-demand content.

As used herein, the term “long-hold” (also referred to herein as “press-and-hold” or “long-press”) may refer to a user input that is a continuous input over a duration of time. For instance, a user may initiate contact with a touchscreen surface, such as by touching or pressing the surface with a finger or other input item, and maintain such contact over a period of time (e.g., one, second, 1.5 seconds, two seconds, and so on). Once the contact has been held for a predefined period of time, an operation mapped to the long-hold input is initiated. Accordingly, the term long-hold represents a continuous user input over a suitable duration of time and without interruption.

The following discussion first describes an operating environment, followed by techniques and procedures that may be employed in this environment. This discussion continues with an example electronic device in which methodologies for long-hold video surfing can be embodied.

Example Environment

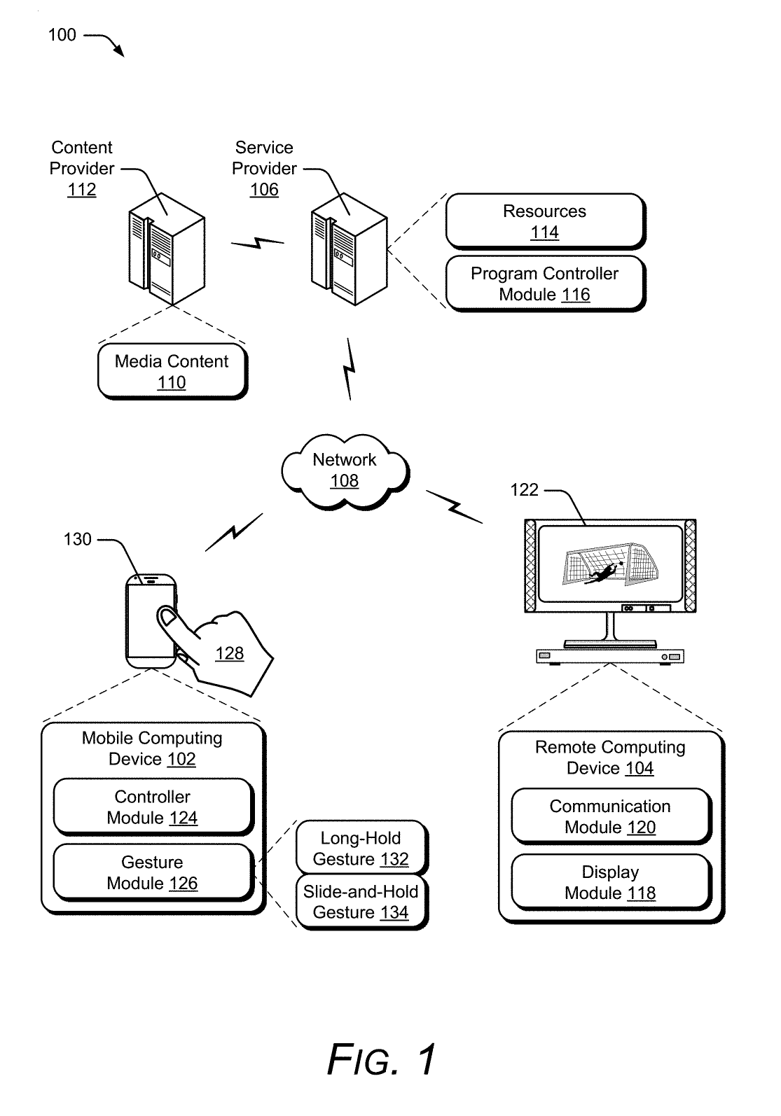

FIG. 1 illustrates an example environment 100 in which methodologies for long-hold video surfing can be embodied. The example environment 100 includes examples of a mobile computing device 102, a remote computing device 104, and a service provider 106 communicatively coupled via a network 108. Functionality represented by the service provider 106 may be performed by a single entity, may be divided across other entities that are communicatively coupled via the network 108, or any combination thereof. Thus, the functionality represented by the service provider 106 can be performed by any of a variety of entities, including a cloud-based service, an enterprise hosted server, or any other suitable entity.

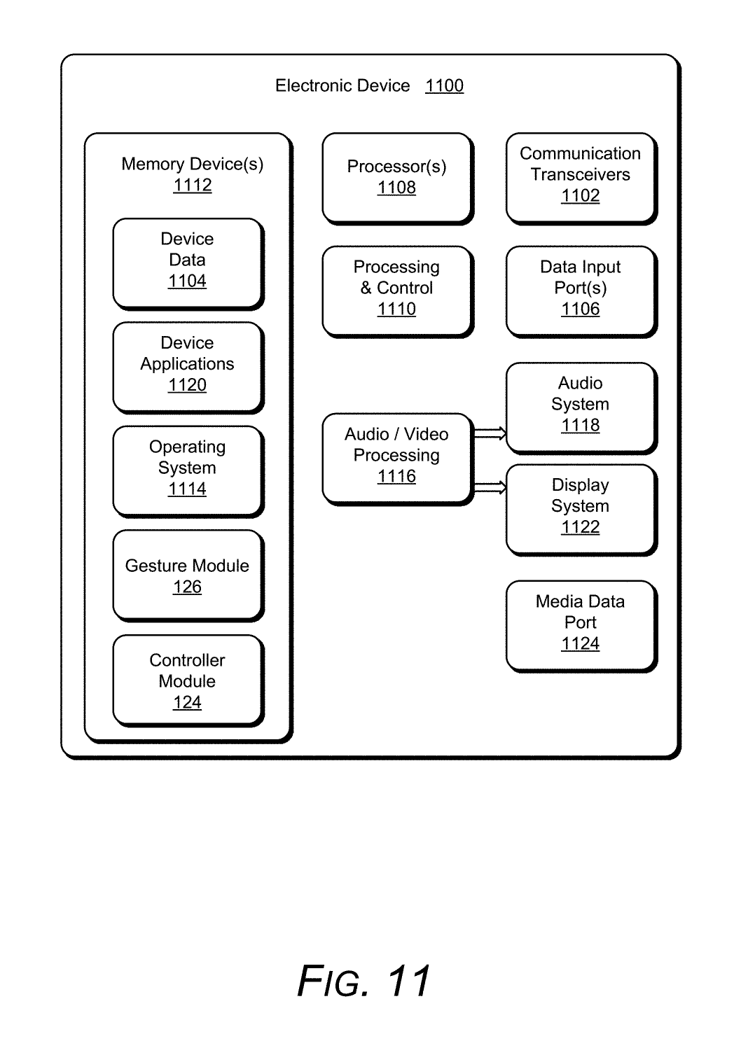

Computing devices that are used to implement the service provider 106, the mobile computing device 102, or the remote computing device 104 may be configured in a variety of ways. Computing devices, for example, may be configured as a desktop computer, a laptop computer, a mobile device (e.g., assuming a handheld configuration such as a tablet or mobile phone), and so forth. Additionally, a computing device may be representative of a plurality of different devices, such as multiple servers of the service provider 106 utilized by a business to perform operations “over the cloud” as further described in relation to FIG. 11.

The service provider 106 is representative of functionality to distribute media content 110 obtained from one or more content providers 112. Generally speaking, the service provider 106 is configured to make various resources 114 available over the network 108 to clients. In the illustrated example, the resources 114 can include program content that has been processed by a program controller module 116. In some implementations, the program controller module 116 can authenticate a user to access a user account that is associated with permissions for accessing corresponding resources, such as particular television stations or channels, from a provider. The authentication can be performed using credentials (e.g., user name and password) before access is granted to the user account and corresponding resources 114. Other resources 114 may be available without authentication or account-based access. The resources 114 can include any suitable combination of services and/or content typically made available over a network by one or more providers. Some examples of services include, but are not limited to: a content publisher service that distributes content, such as streaming videos and the like, to various computing devices, an advertising server service that provides advertisements to be used in connection with distributed content, and so forth. Content may include various combinations of assets, video comprising part of an asset, advertisements, audio, multi-media streams, animations, images, television program content such as television content streams, applications, device applications, and the like.

The content provider 112 provides the media content 110 that can be processed by the service provider 106 and subsequently distributed to and consumed by end-users of computing devices, such as remote computing device 104 and mobile computing device 102. Media content 110 provided by the content provider 112 can include streaming media via one or more channels, such as one or more programs, on demand videos, movies, and so on.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be representative of multiple networks. Further, the mobile computing device 102 can communicate with the remote computing device 104 via a short range network, such as Bluetooth®, infrared (IR), near field communication (NFC), radio frequency (RF), and so on. Alternatively, the mobile computing device 102 can communicate with the service provider 106 via a cellular network while the service provider 106 communicates with the remote computing device 104 via a different network, such as cable, satellite, digital satellite, digital terrestrial television network, and so on. Thus, a variety of different networks 108 can be utilized to implement the techniques described herein.

The remote computing device 104 is illustrated as including a display module 118 and a communication module 120. The display module 118 is configured to utilize a renderer to display media content via a display device 122. The communication module 120 receives the media content 110 from the service provider 106, and processes the media content 110 for display. The communication module 120 is configured to communicate with the service provider 106 to request particular resources 114 and/or media content 110.

The mobile computing device 102 includes a controller module 124 and a gesture module 126. The controller module 124 is configured to generate control commands to the remote computing device 104 to control output of content via the display device 112. For example, the controller module 124 enables the mobile computing device 102 to be used as a remote controller to control operations of the remote computing device 104, such as channel selection, channel preview, volume control, power on/off, and so on. Accordingly, the controller module 124 represents functionality to control a variety of operations associated with output of content via the display device 112.

The gesture module 126 is representative of functionality to identify gestures and cause operations to be performed that correspond to the gestures. The gestures may be identified by the gesture module 126 in a variety of ways. For example, the gesture module 126 can be configured to recognize a touch input, such as a finger of a user's hand 128 as proximate, or in contact with, a gesture-sensitive surface of a display device 130 of the mobile computing device 102 using touchscreen functionality. Other input items can also be used to generate the touch input, such as a stylus.

The touch input may also be recognized as including attributes (e.g., selection point, movement, etc.) that are usable to differentiate the touch input from other touch inputs recognized by the gesture module 126. This differentiation may then serve as a basis to identify a gesture from the other touch inputs, and consequently initiate an operation mapped to the gesture. A variety of different types of gestures may be recognized by the gesture module 126, such as gestures that are recognized from a single type of input (e.g., touch gestures that include an interrupt, such as the user's finger lifting off of the display device 130) as well as gestures involving multiple types of inputs.

For example, in at least one embodiment described herein, the mobile computing device 102 may be configured to detect and differentiate between multiple different gestures without an interrupt between gestures. From the user's perspective, an input item (e.g., the user's finger) may maintain continuous contact with the display device 130 while inputting multiple different gestures to execute multiple different operations.

Accordingly, the gesture module 104 may support a variety of different gestures. Examples of gestures described herein include a long-hold gesture 132 and a slide-and-hold gesture 134. Each of these gestures is described in further detail below.

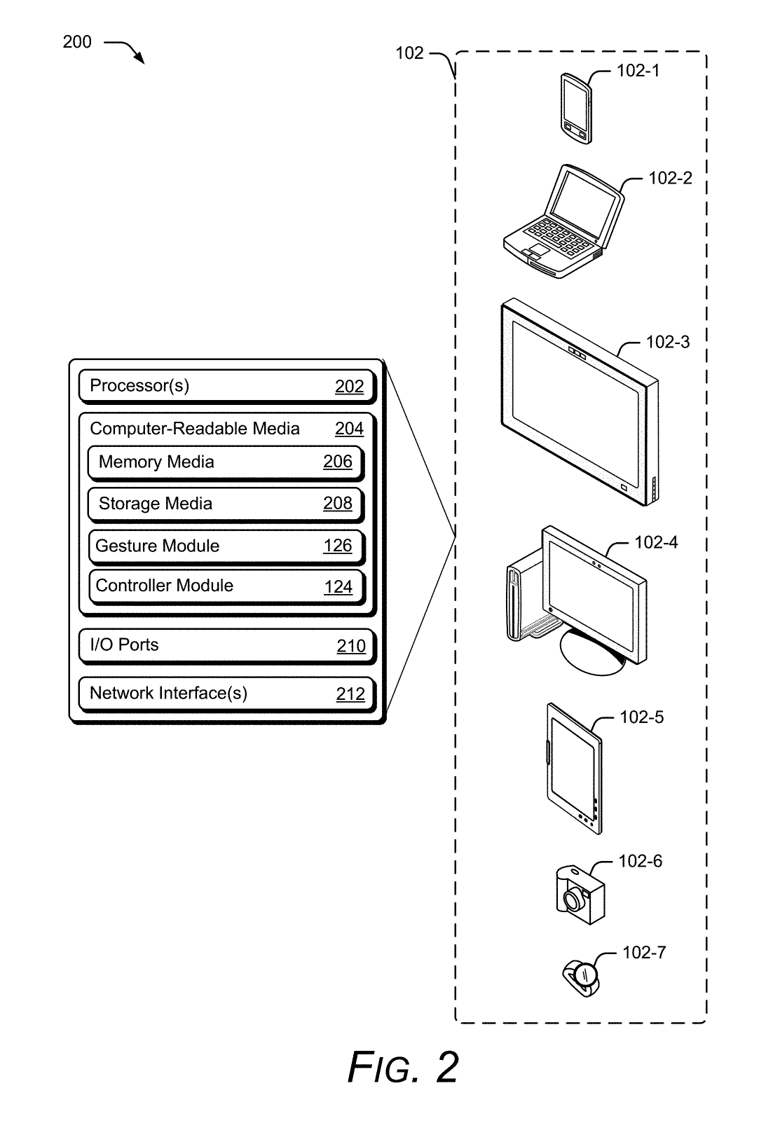

Having generally described an environment in which methodologies for long-hold video surfing may be implemented, this discussion now turns to FIG. 2, which illustrates an example implementation 200 of the mobile computing device 102 of FIG. 1 in greater detail in accordance with one or more embodiments. The mobile computing device 102 is illustrated with various non-limiting example devices: smartphone 102-1, laptop 102-2, television 102-3, desktop 102-4, tablet 102-5, camera 102-6, and smartwatch 102-7. The mobile computing device 102 includes processor(s) 202 and computer-readable media 204, which includes memory media 206 and storage media 208. Applications and/or an operating system (not shown) embodied as computer-readable instructions on the computer-readable media 204 can be executed by the processor(s) 202 to provide some or all of the functionalities described herein, as can partially or purely hardware or firmware implementations. The computer-readable media 204 also includes the gesture module 126, which can recognize user input as one or more gestures, such as the long-hold gesture 132 or the slide-and-hold gesture 134, that are mapped to particular operations to be initiated.

The mobile computing device 102 also includes I/O ports 210 and network interfaces 212. I/O ports 210 can include a variety of ports, such as by way of example and not limitation, high-definition multimedia (HDMI), digital video interface (DVI), display port, fiber-optic or light-based, audio ports (e.g., analog, optical, or digital), USB ports, serial advanced technology attachment (SATA) ports, peripheral component interconnect (PCI) express based ports or card slots, serial ports, parallel ports, or other legacy ports. The mobile computing device 102 may also include the network interface(s) 212 for communicating data over wired, wireless, or optical networks. By way of example and not limitation, the network interface 212 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like.

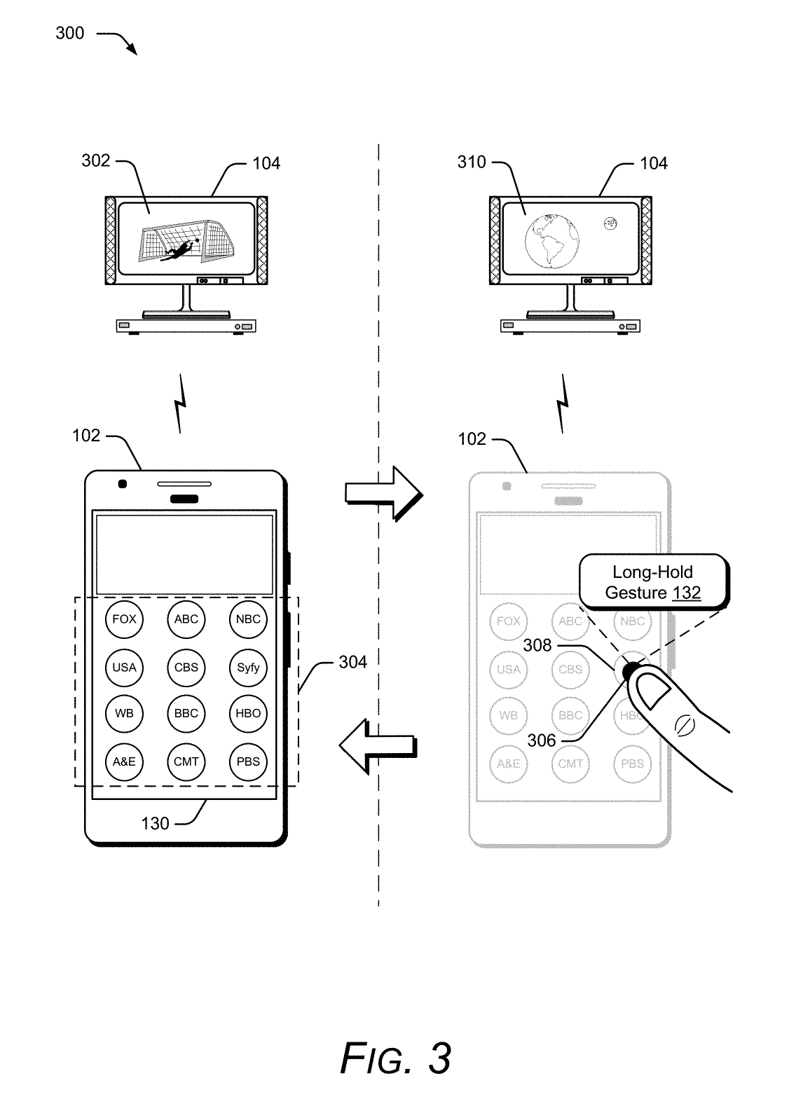

Having described the mobile computing device 102 of FIG. 2 in greater detail, this discussion now turns to FIG. 3, which illustrates an example implementation 300 of a long-hold gesture in accordance with one or more implementations. Similar to channel surfing, “video surfing” is the process of scanning through different videos or television channels to find content of interest. Long-hold video surfing provides functionality, via the mobile computing device 102, to browse through and preview different videos or channels without causing a change to a current video or channel being presented via the remote computing device 104.

In the example scenario 300, the remote computing device 104 is presenting a soccer game 302 currently being broadcast on a particular television channel. The mobile computing device 102 is configured to present, via the display device 130, an arrangement of objects 304 associated with media content. In implementations, one or more of the objects 304 can correspond to a television channel or an on demand video. At least one object 304 can include an icon, an image, a poster representing a particular movie, text, a logo, and so on. Accordingly, the objects 304 can include a wide variety of different objects displayable via the display device 130. In at least one implementation, the objects 304 are selectable to initiate channel surfing functionality and/or channel selection at the remote computing device 102. In the illustrated example, the objects 304 are presented in a matrix and each object 304 represents a television channel associated with a provider. The arrangement of the television channels includes a non-linear arrangement, which contrasts with a linear order generally used by conventional techniques. This allows a user to surf through the channels in any order or fashion, and the user is not limited by traditional sequential channel surfing afforded by a traditional UP/DOWN button on a conventional remote control or an inability of the traditional sequential channel surfing to navigate the channels outside of a list of the channels. For example, in an example list of channels 1-5, the techniques described herein allow the user to navigate from channel three to channel one or channel five without accessing or passing through channel two or channel four, which improves upon conventional techniques that are not capable of such navigation.

In at least one implementation, the user may press and hold (e.g., via touch input 306) a selectable object 308 to initiate long-hold video surfing. Based on a location and a duration of the touch input 306, the mobile computing device 102 can recognize the user input as a long-hold gesture, and map the user input to a corresponding operation. In the scenario 300, the long-hold gesture is recognized at a location corresponding to a Syfy® channel, and causes the mobile computing device 102 to communicate a channel preview command to the remote computing device 104. The channel preview command causes the remote computing device 104 to present a science show 310 about planets currently being distributed via the Syfy® channel, without changing the current channel of the remote computing device 104 that is providing the soccer game 302. Rather, the soccer game 302 is paused while the preview of the science show 310 is presented. In implementations, the soccer game 302 can be paused, whether on live television or on demand streaming, by using one or more buffers. The buffers can be implemented by the remote computing device 104, the service provider 106, or a combination thereof. Any suitable buffer can be utilized, such as a digital video recorder (DVR) or the like.

In at least one implementation, when the user releases the long-hold gesture 132 (e.g., the user's finger is removed from contact with the surface of the mobile computing device 102), the mobile computing device 102 recognizes an interrupt in the long-hold gesture 132 and terminates the preview of the science show 310 on the Syfy® channel. Then, the remote computing device 104 can close the preview of the science show 310, and resume playback of the soccer game 302. In this way, the user can preview a variety of channels or videos without causing a channel change, and without missing any of the video playing on the current channel. Further, these techniques do not require the user to remember which channel is the current channel in order to return to it.

To initiate a channel change at the remote computing device 104, for example, the user may enter a different input, such as a tap or double tap on the corresponding object 308. Alternatively, the channel change can be initiated if the long-hold gesture 132 is held for more than a predefined duration of time, further discussion of which is provided below in more detail.

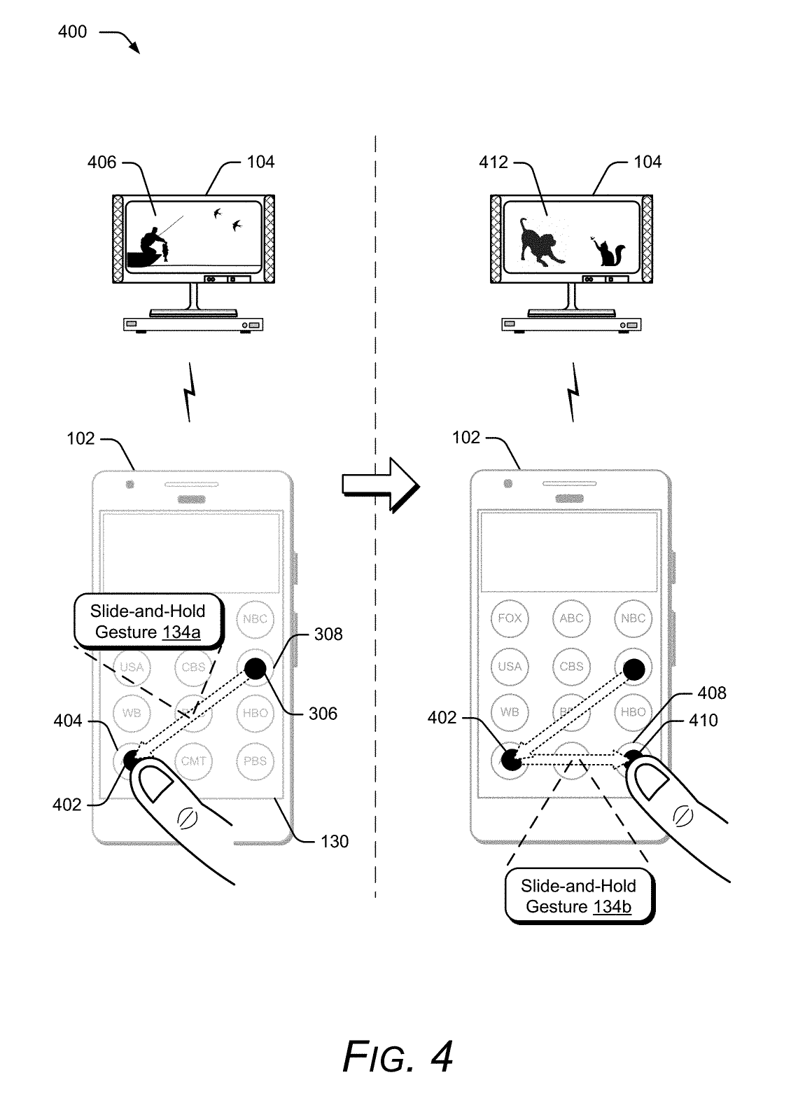

FIG. 4 illustrates an example scenario 400 of a slide-and-hold gesture in accordance with one or more embodiments. Continuing with the example scenario 300 in FIG. 3, where the user is holding the object 308 via touch input 306, the user now desires to surf to a different channel. To do this, the user can slide his finger from the object 308 to another object displayed via the display device 130. The gesture module 126 recognizes this type of input as the slide-and-hold gesture 134, which is mapped to an operation that initiates a preview of a newly selected channel. In the example scenario 400, the touch input 306 is moved from the object 308 corresponding to the Syfy® channel to touch input 402 corresponding to object 404, which is associated with A&E. In implementations, the gesture module 126 recognizes the long-hold gesture 132 and the slide-and-hold gesture 134 as a continuous touch input without interruption.

The mobile computing device 102 then communicates a channel preview command to the remote computing device 104 to cause the remote computing device 104 to present content being streamed via a channel associated with A&E, such as a fishing show 406. Meanwhile, the content of the originally viewed channel, e.g., the soccer game 302, is still paused and can be resumed when the gesture is interrupted. Here, the user does not find the fishing show 406 interesting, and slides his finger to yet another object 408, maintaining contact with the surface of the mobile computing device 102 from the touch input 402 to touch input 410. The gesture module 126 recognizes this type of input as slide-and-hold gesture 134b. The other object 408 corresponds to a channel associated with PBS, which is currently distributing an animal show 412, and is presented via the remote computing device 104. In implementations, the gesture module 126 recognizes the combination of the long-hold gesture 132, the slide-and-hold gesture 134a, and the slide-and-hold gesture 134b as a continuous touch input without interruption. In this way, the user can surf a wide variety of channels in a non-linear fashion, without having to look down at the mobile computing device 102, and without being limited to a linear navigation through a sequential list of channels. Further, the user can easily return to the current channel (e.g., soccer game 302) simply by ending the presentation of previews, without initiating a specific channel number command to return to the current channel.

After previewing the animal show 412, the user may decide to return to the soccer game 302. To do this, the user can simply release the object 408 by lifting or removing an input item (e.g., his finger) from contact with the mobile computing device 102, which results in an interrupt. In response to receiving an interrupt during the slide-and-hold gesture 134, the mobile computing device 102 sends a preview-termination command to the remote computing device 104 to cause the remote computing device 104 to close the preview of the animal show 412 and resume playback of the soccer game 302.

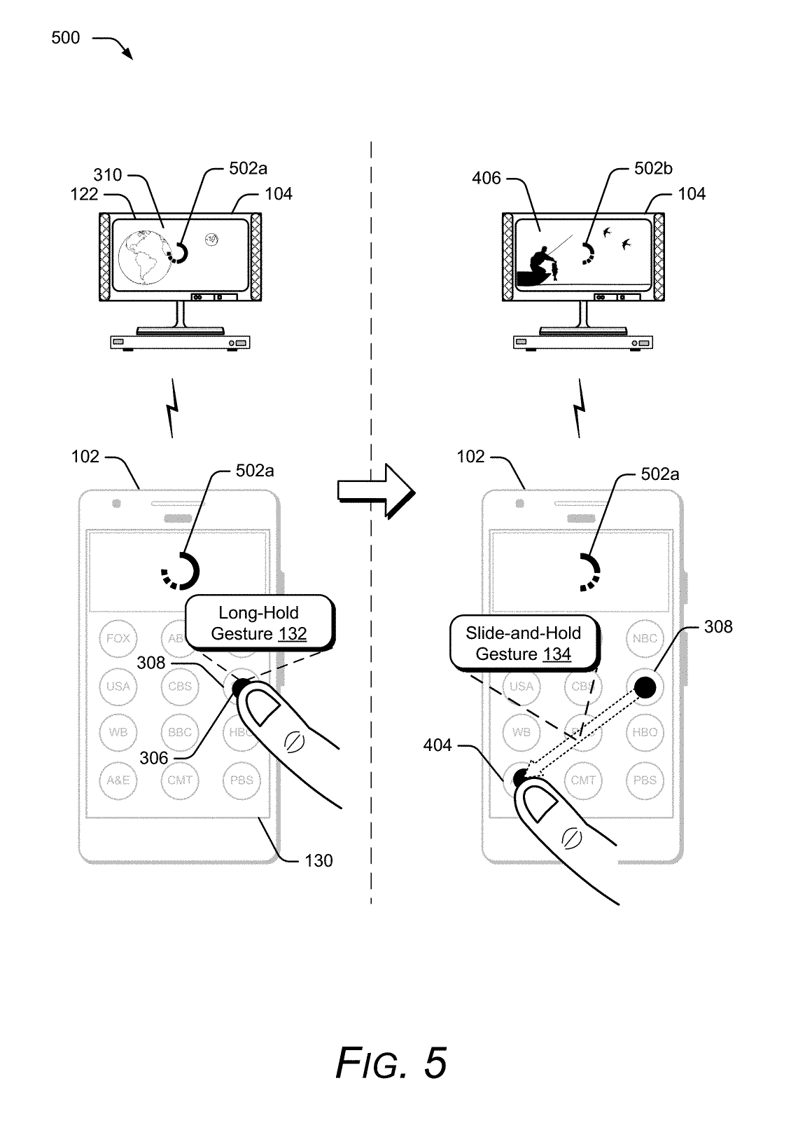

FIG. 5 illustrates an example scenario 500 that implements a timing aspect of long-hold video surfing in accordance with one or more embodiments. Continuing with the example scenarios 300 and 400 in FIGS. 3 and 4, respectively, a user initiates touch input 306 by pressing and holding the object 308. The gesture module 126 recognizes the touch input 306 as long-hold gesture 132. Based on this gesture, the remote computing device 104 presents the science show 310 about planets, which is distributed via the currently selected Syfy® channel. The science show 310 is presented as a preview, and the soccer game 302 is currently paused during the preview of the science show 310.

During the long-hold gesture 132, a timer 502a can be presented via the display device 122 of the remote computing device 104, the display device 130 of the mobile computing device 102, or both. The timer 502a can include any of a variety of forms, such as an animated line that progressively grows into a circle or other shape, a rectangular timeline showing progression from zero to a predefined number of seconds, a flashing or blinking symbol or pattern, and so on. The timer 502a provides an indication as to how long the long-hold gesture 132 has been held. In addition, the timer 502a indicates when the duration of the long-hold gesture 132 will reach a threshold time, such as 5 seconds, 8 seconds, 10 seconds, and so on. In implementations, when the long-hold gesture 132 is held for at least a predefined period of time, the mobile computing device 102 automatically communicates a channel change command to the remote computing device 104 to change to a corresponding channel and continue viewing content streamed by that channel.

If a slide-and-hold gesture 134 to a new channel is recognized prior to the completion of the timer 502a, then the timer 502a restarts and timer 502b is presented during a preview of the new channel. In the illustrated example, before the timer 502a completes a full circle, the user performs a slide-and-hold gesture 134 by sliding his finger from the object 308 (e.g., Syfy® channel) to object 404 (e.g., A&E channel). The timer 502a then restarts, and is presented as timer 502b, to give the user a new set of seconds to preview the fishing show 406 on the A&E channel. As above, the timer 502b can be displayed via the remote computing device 104 so the user does not need to look down at the mobile computing device 102. Alternatively or additionally, the timer 502b can be presented via the mobile computing device 102 so as to avoid interrupting or obscuring content presented via the remote computing device 104. In at least one embodiment, the timer 502b can be presented via both the mobile computing device 102 and the remote computing device 104 to ensure that the user is aware of the timing of the long-hold gesture 132.

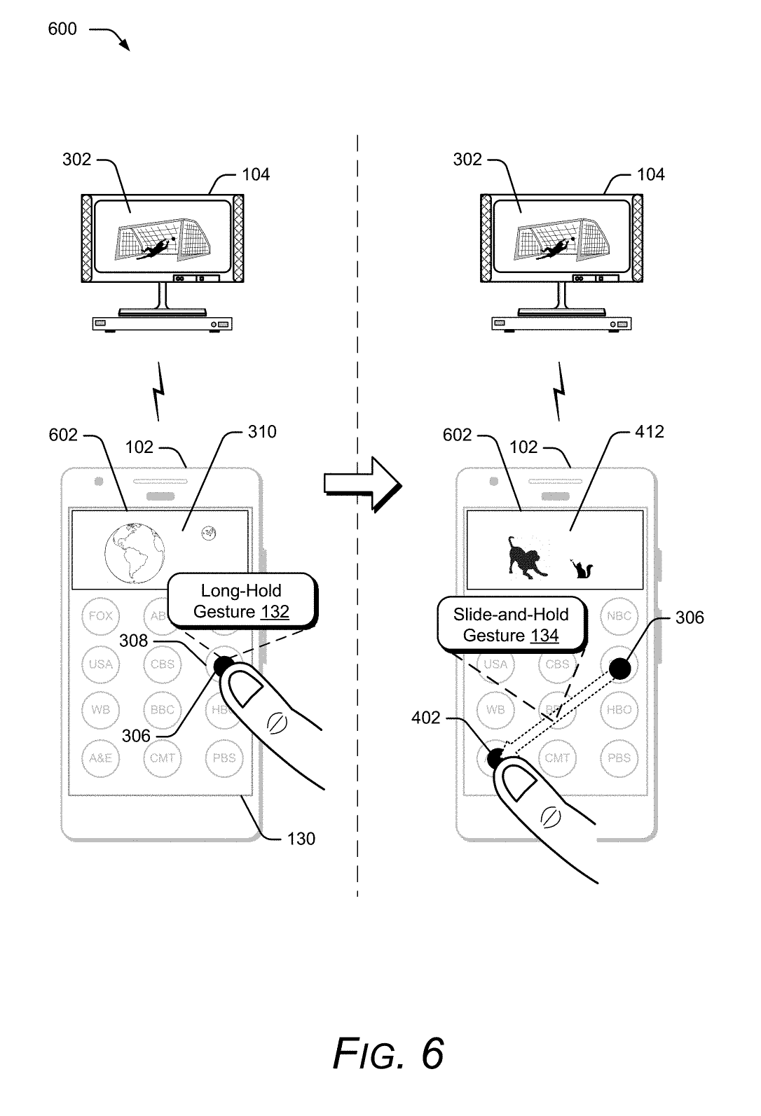

FIG. 6 illustrates an example scenario 600 in which techniques for long-hold video surfing are implemented in accordance with one or more embodiments. In implementations, the preview of the new channel can be presented via the mobile computing device 102 to avoid interrupting a currently presented show at the remote computing device 104. In the illustrated scenario 600, for example, the remote computing device 104 is presenting the soccer game 302. The mobile computing device 102 recognizes the touch input 306 as long-hold gesture 132 associated with object 308, and initiates a channel preview command associated with the selected object 308 (e.g., Syfy® channel). The mobile computing device 102 presents a preview of the science show 310 on the Syfy® channel via a graphical user interface 602, such as a window 702, of the display device 130, rather than initiating the preview at the remote computing device 104. In this way, the soccer game 302 is not interrupted, and the user can preview the Syfy® channel via the mobile computing device 102.

If the Syfy® channel is not interesting at this moment, the user can perform the slide-and-hold gesture 134 to a new channel (e.g., A&E channel corresponding to touch input 402) to initiate presentation of the animal show 412 corresponding to that channel. The mobile computing device 102 presents the animal show 412 as a preview without interrupting the soccer game 302 being presented at the remote computing device 104.

Consider an example where a group of people are watching the soccer game 302. Without interrupting the soccer game 302, the user can surf channels using these techniques to view what is being distributed on other channels. Then, when the soccer game 302 is halted, or a commercial break is initiated, the user can quickly switch to a different channel (e.g., a football game). This enables the user to quickly and efficiently switch between desired channels without interrupting the current show from the perspective of other viewers in the room.

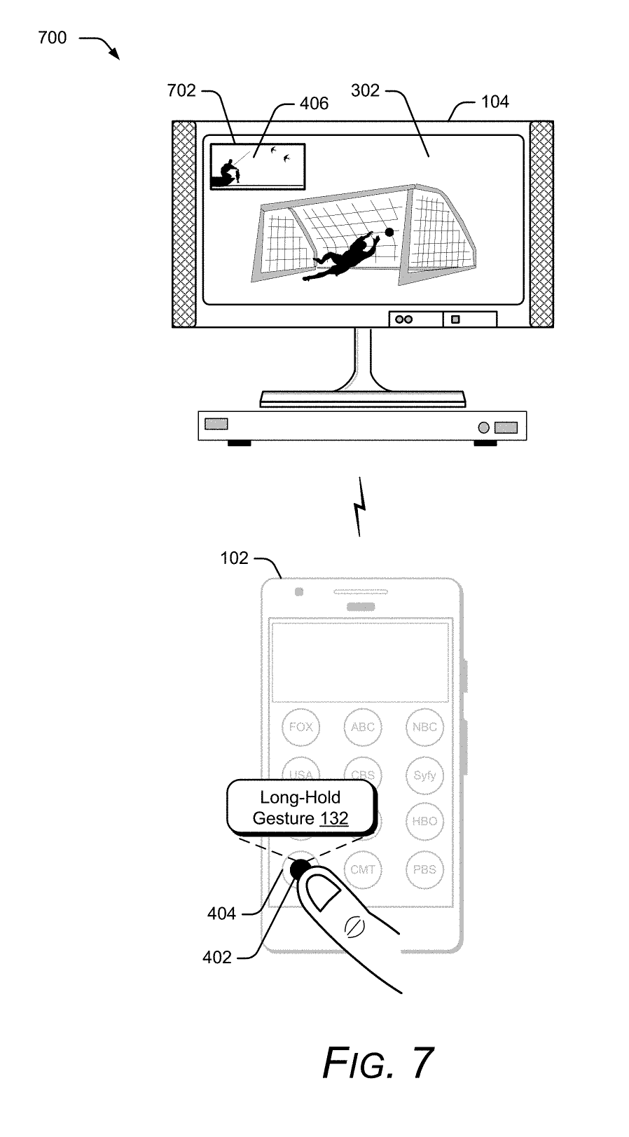

FIG. 7 illustrates an example scenario 700 in which techniques for long-hold video surfing can be implemented in accordance with one or more embodiments. For example, while viewing the soccer game 302, the user desires to surf other channels. In the example scenario 700, the user initiates touch input 402 to perform long-hold gesture 132 to view content distributed by the A&E channel. In at least one implementation, aspect window 702 (e.g., popup, overlay, portion of a display area of the display device 122, and so on) is provided by the remote computing device 104. This enables the user to simultaneously view the soccer game 302 on the current channel and the fishing show 406 on the A&E channel. Accordingly, the techniques described herein can be implemented in a variety of different ways to present previews of content distributed via different channels to allow a user to channel surf without actually changing the current channel.

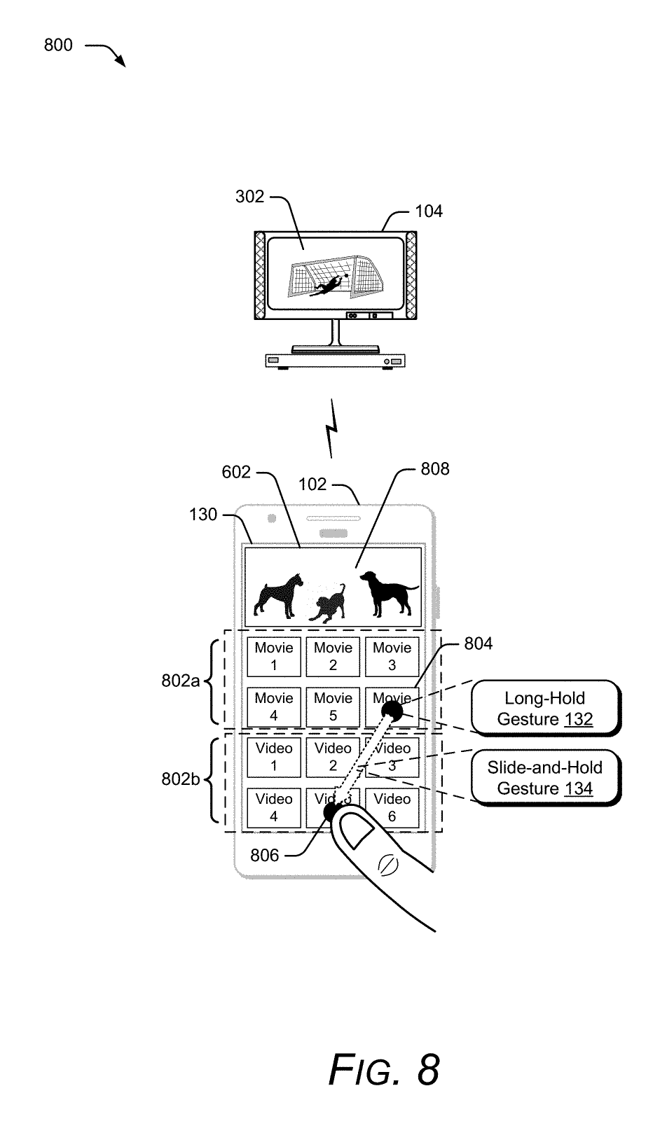

FIG. 8 illustrates an example scenario 800 in which a mobile computing device includes a user interface 602 that facilitates long-hold video surfing in accordance with one or more implementations. The example scenario 800 depicts an example mobile computing device 102 being used as a remote control for a remote computing device 104, similar to the discussion above with respect to FIGS. 3-7. Multiple different objects are presented via the display device 130 of the mobile computing device 102. These objects can be arranged in any of a variety of different configurations. In implementations, at least some objects 802a correspond to items in a movie catalog, such as movies accessible via an online service that provides streaming content on demand. Alternatively or additionally, at least some objects 802b correspond to videos stored in a local database, such as videos captured by the mobile computing device 102 or other user device, videos downloaded via a content sharing platform (e.g., social media site), videos received via email, and so on. Rather than a local database, the videos can be stored in a cloud storage which is accessible by the mobile computing device 102 over the network 108. In implementations, the objects presented via the user interface 602 can correspond to media content stored in a variety of different locations, hosted by a variety of different sources, or any combination of locations and sources. As discussed above, the at least some objects can correspond to television channels, television programs, providers of television content, or on-demand videos. Accordingly, the objects can correspond to a variety of different media content, sources of the media content, providers of the media content, or any combination thereof.

In the example scenario 800, the remote computing device 104 is presenting the soccer game 302 corresponding to a particular television channel. During the presentation of the soccer game 302, the user uses the mobile computing device 102 to preview other content by pressing and holding a movie poster 804 that corresponds to a trailer of a particular movie (e.g., Movie 6). The preview is presented via the user interface 602 of the mobile computing device 102 so as to not interrupt the soccer game 302 displayed at the remote computing device 104. However, as discussed above, the soccer game 302 can be paused to present the trailer at the remote computing device 104. The user decides to continue surfing, and while maintaining contact with the surface of the mobile computing device 102, slides his finger from the movie poster 804 down to object 806, which corresponds to a locally stored video (e.g., Video 5) of his dogs playing 808. While holding the object 806, the mobile computing device 102 recognizes the slide and hold input as a slide-and-hold gesture 134 and presents a portion (e.g., 10 seconds) of his dogs playing 808 via the display device 130 of the mobile computing device 102.

Using these techniques, the user can easily and efficiently surf through different selected movies, videos, channels, and so on, and view a portion of content associated with each selection. At least some of the movies, videos, or channels can be accessible on demand via an on demand service or local storage. At least some of the movies, videos, or channels can be accessible via a subscription-based service, a free-of-charge service, an online catalog, an over-the-air broadcast service, or any combination thereof.

Example Methods

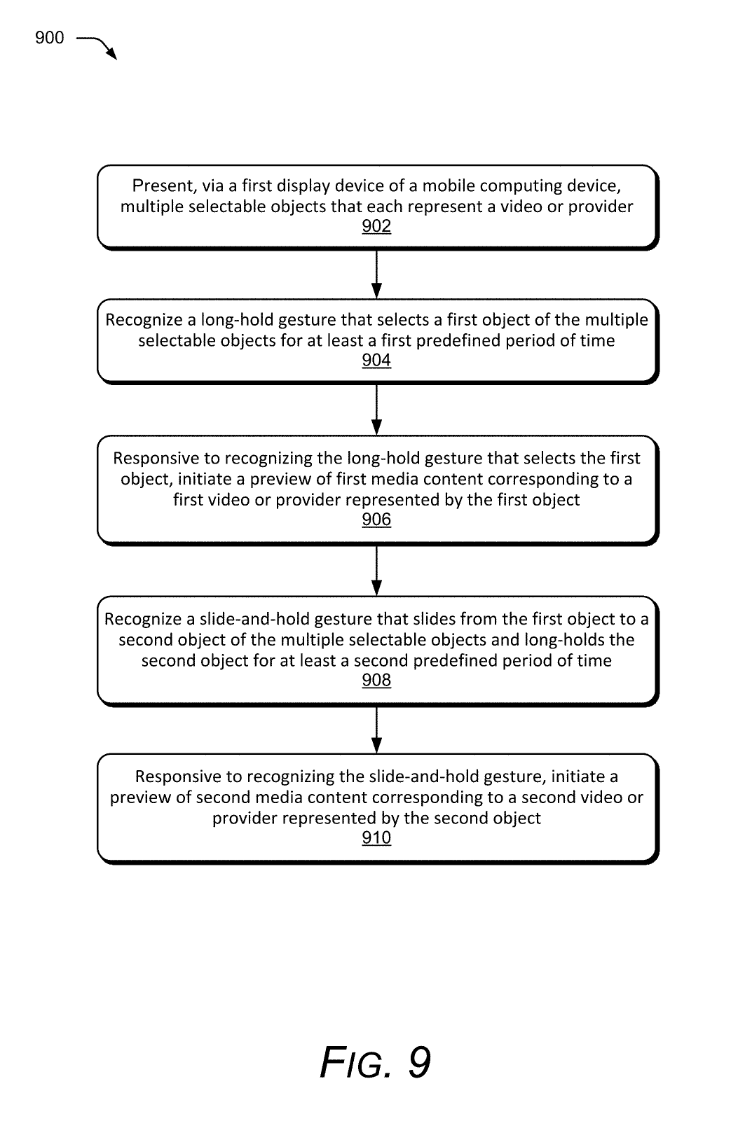

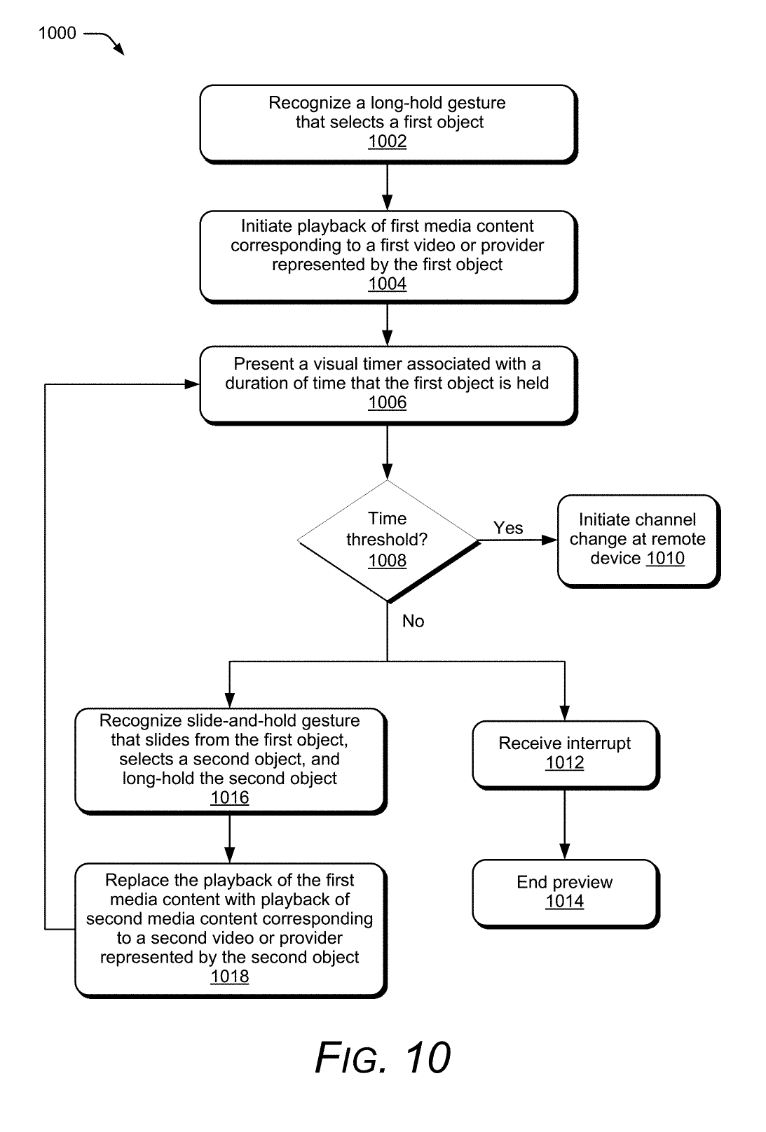

The following discussion describes methods by which techniques are implemented to enable use of methodologies for long-hold video surfing. These methods can be implemented utilizing the previously described environment and example systems, devices, and implementations, such as shown in FIGS. 1-8. Aspects of these example methods are illustrated in FIGS. 9 and 10, which are shown as operations performed by one or more entities. The orders in which operations of these methods are shown and/or described are not intended to be construed as a limitation, and any number or combination of the described method operations can be combined in any order to implement a method, or an alternate method.

FIG. 9 illustrates example methods 900 of navigating media content using methodologies for long-hold video surfing in accordance with one or more embodiments. At 902, multiple selectable objects that each represent a video or provider are presented via a first display device of a mobile computing device. In at least one implementation, one or more of the objects represent a television program, an on demand movie, a locally stored video, a video shared via social media, a television channel, or a provider of television content. The objects can represent any of a variety of different video content, such as objects described with respect to FIGS. 3 and 8.

At 904, a long-hold gesture is recognized that selects a first object of the multiple selectable objects for at least a predefined period of time. For example, a touch input (e.g., press and hold) can be received at a location corresponding to the first object. The touch input is held for a duration of time that exceeds a threshold (e.g., 0.5 seconds, one (1) second, 1.5 seconds, and so forth).

At 906, responsive to recognizing the long-hold gesture that selects the first object, playback is initiated of first media content corresponding to a first video or provider represented by the first object. For example, the mobile computing device 102 can initiate playback of the first media content via the display device 130 of the mobile computing device 102, or alternatively transmit remote control commands to the remote computing device 104 to pause currently playing content and initiate playback of the first media content via the display device 122 of the remote computing device 104. In implementations, the playback of the first media content is temporary, such that the first media content is played back for a predefined duration of time (e.g., ten seconds, 12 seconds, and so forth). In at least some implementations, the actual first media content is played back rather than a trailer, an advertisement, or a teaser version of the first media content. In implementations, the first media content is played back at a particular scene based on a time of distribution of the first media content.

At 908, a slide-and-hold gesture is recognized that slides from the first object to a second object of the multiple selectable objects and long-holds the second object for at least a second predefined period of time. For example, without releasing the touch input, the touch input slides across the surface of the mobile computing device from the first object to a second object and holds the second object. In implementations, the second predefined period of time can match the first predefined period of time. Alternatively, the second predefined period of time can be either a relatively shorter period of time or a relatively longer period of time than the first predefined period of time. Any suitable period of time can be utilized.

At 910, responsive to recognizing the slide-and-hold gesture, a preview is initiated of second media content corresponding to a second video or provider represented by the second object. For example, the preview of the first media content is replaced with playback of the second media content, while the second object is held.

FIG. 10 illustrates example methods 1000 for presenting media content using methodologies for long-hold video surfing in accordance with one or more embodiments. At 1002, a long-hold gesture is recognized that selects a first object. For example, the long-hold gesture is recognized at a mobile computing device that is configured to remotely control playback of content at a remote device. At 1004, a preview is initiated of first media content corresponding to a first video or provider represented by the first object. This operation can be performed in any suitable way, such as is described with respect to FIG. 9.

At 1006, a visual timer is presented that is associated with a duration of time that the long-hold gesture is held. Any suitable visual timer can be utilized, examples of which are described above. At 1008, a determination is made as to whether the long-hold gesture is held longer than a time threshold. For example, a user can maintain contact (e.g., touch input) with a same location on the gesture-sensitive surface of the mobile computing device for a period of time, such as one (1) second or more. If the touch input is held longer than the time threshold (“YES”), then at 1010 the mobile computing device initiates a channel change at the remote device, such as via a channel-change command.

The time threshold may not be reached (“NO”) for any of a variety of different causes. For example, at 1012 an interrupt is received. In at least one implementation, the user may lift his finger or other input item from the gesture sensitive surface of the mobile computing device, thus removing contact with the gesture-sensitive surface. This action interrupts the long-hold gesture, and at 1014, ends the preview. For example, presentation of the first media content is closed or otherwise ended. In at least one implementation, the mobile computing device automatically communicates a remote control command to the remote device to end the preview and resume playback of previous content that was being played back prior to the long-hold gesture being recognized at the mobile computing device.

Alternatively, at 1016, a slide-and-hold gesture is recognized that slides from the first object, selects a second object, and long-holds the second object. For example, prior to the time threshold being reached with respect to the long-hold gesture on the first object, the touch input is moved across the gesture-sensitive surface to a new location corresponding to the second object. The slide-and-hold gesture selects the second object and maintains contact with this new location for a period of time.

At 1018, a preview is initiated of second media content corresponding to a second video or provider represented by the second object. While the slide-and-hold gesture long-holds the second object, the corresponding media content is presented for preview, examples of which are provided above. In at least some implementations, the preview of the corresponding media content replaces the playback of the first media content without causing the remote device to change channels. Further, based on the selected second object, the process returns to 1006, where a new visual timer is presented, or the previous visual timer restarts, to indicate a duration of time that the second object is selected and held via the slide-and-hold gesture.

These methodologies allow a user to surf through different videos or content provided by providers in an easy, efficient, and non-linear manner. Using these techniques, the user can preview any of a variety of different content simply by moving his finger around the gesture-sensitive surface of the mobile computing device, and either return to previously playing content by removing contact with the gesture-sensitive surface or initiating a channel change by holding a particular object for longer than the time threshold.

Example Electronic Device

FIG. 11 illustrates various components of an example electronic device 800 that can be utilized to implement long-hold video surfing as described with reference to any of the previous FIGS. 1-10. The electronic device may be implemented as any one or combination of a fixed or mobile device, in any form of a consumer, computer, portable, user, communication, phone, navigation, gaming, audio, camera, messaging, media playback, and/or other type of electronic device, such as computing device 102 described with reference to FIGS. 1 and 2.

Electronic device 800 includes communication transceivers 802 that enable wired and/or wireless communication of device data 804, such as received data, transmitted data, or sensor data as described above. Example communication transceivers include NFC transceivers, WPAN radios compliant with various IEEE 802.15 (Bluetooth™) standards, WLAN radios compliant with any of the various IEEE 802.11 (WiFi™) standards, WWAN (3GPP-compliant) radios for cellular telephony, wireless metropolitan area network (WMAN) radios compliant with various IEEE 802.16 (WiMAX′) standards, and wired local area network (LAN) Ethernet transceivers.

Electronic device 800 may also include one or more data input ports 806 via which any type of data, media content, and/or inputs can be received, such as user-selectable inputs, messages, music, television content, recorded video content, and any other type of audio, video, and/or image data received from any content and/or data source (e.g., other video devices). Data input ports 806 may include USB ports, coaxial cable ports, and other serial or parallel connectors (including internal connectors) for flash memory, DVDs, CDs, and the like. These data input ports may be used to couple the electronic device to components (e.g., image sensor 104), peripherals, or accessories such as keyboards, microphones, or cameras.

Electronic device 800 of this example includes processor system 808 (e.g., any of application processors, microprocessors, digital-signal-processors, controllers, and the like), or a processor and memory system (e.g., implemented in a SoC), which process (e.g., execute) computer-executable instructions to control operation of the device. Processor system 808 may be implemented as an application processor, embedded controller, microcontroller, and the like. A processing system may be implemented at least partially in hardware, which can include components of an integrated circuit or on-chip system, digital-signal processor (DSP), application-specific integrated circuit (ASIC), field-programmable gate array (FPGA), a complex programmable logic device (CPLD), and other implementations in silicon and/or other hardware.

Alternatively or in addition, electronic device 800 can be implemented with any one or combination of software, hardware, firmware, or fixed logic circuitry that is implemented in connection with processing and control circuits, which are generally identified at 810 (processing and control 810).

Although not shown, electronic device 800 can include a system bus, crossbar, or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Electronic device 800 also includes one or more memory devices 812 that enable data storage, examples of which include random access memory (RAM), non-volatile memory (e.g., read-only memory (ROM), flash memory, EPROM, EEPROM, etc.), and a disk storage device. Memory device(s) 812 provide data storage mechanisms to store the device data 804, other types of information and/or data, and various device applications 820 (e.g., software applications). For example, operating system 814 can be maintained as software instructions within memory device 812 and executed by processors 808. In some aspects, gesture module 126 and controller module 124 are embodied in memory devices 812 of electronic device 800 as executable instructions or code. Although represented as a software implementation, gesture module 126 and controller module 124 may be implemented as any form of a control application, software application, signal-processing and control module, or hardware or firmware installed on the electronic device 800.

Electronic device 800 also includes audio and/or video processing system 816 that processes audio data and/or passes through the audio and video data to audio system 818 and/or to display system 822 (e.g., a screen of a smart phone or camera). Audio system 818 and/or display system 822 may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 824. In some implementations, audio system 818 and/or display system 822 are external components to electronic device 800. Alternatively or additionally, display system 822 can be an integrated component of the example electronic device, such as part of an integrated touch interface.

Although embodiment of methodologies for long-hold video surfing have been described in language specific to features and/or methods, the subject of the appended claims is not necessarily limited to the specific features or methods described. Rather, the specific features and methods are disclosed as example implementations of long-hold video surfing.

What is claimed is:

1. In a digital medium environment that utilizes a mobile computing device as a remote controller for a remote device, a method implemented by the mobile computing device, the method comprising:
recognizing, by the mobile computing device, a long-hold gesture that selects a first object of multiple selectable objects for at least a first predefined period of time, the multiple selectable objects displayed via a first display device of the mobile computing device, each said object representing a video or provider;
responsive to recognizing the long-hold gesture that selects the first object, initiating, by the mobile computing device, playback of first media content corresponding to a first program or provider represented by the first object;
recognizing a slide-and-hold gesture that slides from the first object to a second object of the multiple selectable objects and long-holds the second object for at least a second predefined period of time; and
responsive to recognizing the slide-and-hold gesture, initiating playback of second media content corresponding to a second program or provider represented by the second object.

2. A method as described in claim 1, wherein the long-hold gesture and the slide gesture are recognized as a continuous touch input without interruption.

3. A method as described in claim 1, further comprising communicating initiation commands to the remote device to cause at least one of the playback of the first media content or the playback of the second media content to be initiated for display via a second display device of the remote device.

4. A method as described in claim 1, further comprising:
receiving an interrupt during the long-hold of the second object based on an input item being removed from contact with the display device of the mobile computing device; and
responsive to receiving the interrupt, automatically initiating a channel change at the remote device to cause the second media content to be displayed for viewing via a second display device of the remote device.

5. A method as described in claim 1, further comprising:
determining that the second object is held for at least a threshold period of time; and
responsive to the determining, automatically initiating a display of the second media content for viewing via a second display device of the remote device.

6. A method as described in claim 1, further comprising:
receiving an interrupt during the long-hold of the second object based on an input item being removed from contact with the display device of the mobile computing device prior to the second object being held for at least a threshold period of time; and
responsive to receiving the interrupt, automatically communicating control commands to the remote device to cause the remote device to end the playback of the second media content and return to previous media content that was being played back prior to the long-hold gesture being recognized at the mobile computing device.

7. A method as described in claim 1, wherein at least one of the first media content or the second media content includes television content.

8. A method as described in claim 1, wherein at least one of the first media content or the second media content includes on-demand media content.

9. A method as described in claim 1, wherein the multiple selectable objects are presented in a non-linear arrangement via the first display device of the mobile computing device.

10. A method as described in claim 1, wherein at least one of the first media content or the second media content is displayed at the first display device of the mobile computing device without interrupting additional content being displayed via a second display device of the remote device.

11. In a digital medium environment to remotely control navigation of media content presented at a remote device, a mobile device comprising:
a display device;
at least one computer-readable storage media storing instructions as a gesture module; and
at least one processor configured to execute the instructions to implement the gesture module, the gesture module configured to:
recognize a long-hold gesture that selects and holds a first object of a plurality of objects displayed via the display device, the first object representing a first video, the long-hold gesture holding the first object for at least a time threshold; and
responsive to the long-hold gesture being recognized, cause the remote device to initiate playback of the first video for viewing via an additional display device of the remote device for a duration of the long-hold gesture and without causing a channel change at the remote device.

12. A mobile device as described in claim 11, wherein each of the plurality of objects represents one of a television program, a provider of television content, a television channel associated with the provider of television content, or an on-demand video.

13. A mobile device as described in claim 11, wherein the gesture module is configured to communicate control commands to the remote device to cause the remote device to pause playback of currently playing content and initiate the playback of the first video via the additional display device of the remote device.

14. A mobile device as described in claim 11, wherein the gesture module is further configured to, responsive to the long-hold gesture holding the first object for at least a predefined period of time, cause the remote device to change channels to continue the playback of the first video.

15. A mobile device as described in claim 11, wherein the gesture module is further configured to:
recognize a slide-and-hold gesture that slides from the first object to a second object without removing contact of an input item with a gesture-sensitive surface of the mobile device, wherein the long-hold gesture and the slide-and-hold gesture are recognized as a continuous touch input without interruption; and
in response to recognition of the slide-and-hold gesture, end the playback of the first video and initiate playback of a second video represented by the second object via the additional display device of the remote device without causing the remote device to change channels.

16. A mobile device as described in claim 15, wherein the gesture module is further configured to:
receive an interrupt during the slide-and-hold gesture; and
responsive to interrupt, end the playback of the second video and resume playback of previous content that was playing prior to initiation of the playback of the first video.

17. In a digital medium environment that utilizes a mobile computing device as a remote controller for a remote device, a method implemented by the mobile device, the method comprising:
recognizing, by the mobile device, a long-hold gesture that selects and holds a first object of a plurality of objects displayed via a user interface of the mobile device, each object mapped to media content associated with a video or a provider;
responsive to recognizing the long-hold gesture, initiating playback of first media content corresponding to a first video or provider represented by the first object, the playback of the first media content initiated by at least wirelessly communicating control commands to the remote device to cause the remote device to pause currently playing media content and begin the playback of the first media content;
presenting a visual timer associated with a duration of time that the first object is held via the long-hold gesture; and
performing an operation based on the duration of time in comparison to a time threshold.

18. A method as described in claim 17, further comprising:
prior to the duration of time exceeding the time threshold, recognizing a slide-and-hold gesture that slides from the first object to a second object of the plurality of objects and holds the second object for an additional duration of time, wherein the second object represents to a second video or provider; and
replacing the playback of the first media content with playback of second media content corresponding to the second video or provider without causing the remote device to change channels.

19. A method as described in claim 17, wherein the operation performed includes one of:
responsive to the duration of time exceeding the time threshold, initiating a channel change at the remote device to continue the playback of the first media content;
responsive to receiving an interrupt prior to the duration of time reaching the time threshold, ending the preview and resuming playback of the currently playing media content; or
responsive to recognizing a slide-and-hold gesture that slides from the first object to a second object of the plurality of objects prior to the duration of time reaching the time threshold, replacing the playback of the first media content with playback of second media content associated with a second video or provider represented by the second object.

20. A method as described in claim 17, wherein at least one of the first media content or the second media content includes television content.
